(19) United States
(12) Patent Application Publication
(10) Pub. No.: US 2025/0210632 A1
(43) Pub. Date: Jun. 26, 2025

(54) BIPOLAR ELECTRODE AND POWER STORAGE DEVICE

(71) Applicant: TOYOTA JIDOSHA KABUSHIKI KAISHA, Toyota-shi (JP)

(72) Inventor: Momoko PROCTER, Seto-shi (JP)

(73) Assignee: TOYOTA JIDOSHA KABUSHIKI KAISHA, Toyota-shi (JP)

(21) Appl. No.: 18/889,418

(22) Filed: Sep. 19, 2024

(30) Foreign Application Priority Data
Dec. 26, 2023 (JP) 2023-219076

(51) Int. Cl. H01M 4/36; H01M 4/02; H01M 10/0525

(52) U.S. Cl. CPC H01M 4/366; H01M 2004/021; H01M 2004/029; H01M 10/0525

(57) ABSTRACT

In the bipolar electrode, a cathode active material layer, an electrode current collector, and an anode active material layer are provided in this order, the cathode active material layer includes a first cathode active material and a second cathode active material having a layered crystal structure, the first cathode active material has a number-based first particle size distribution, the second cathode active material has a number-based second particle size distribution, and the first cathode active material and the second cathode active material satisfy the following relationship (1): 1.5<(D₁50/D₂50)≤15 (1). In Expression (1), D₁50 indicates a particle size having an integrated value of 50% in the first particle size distribution, and D₁50 has a unit of μm, and in Expression (1), D₂50 indicates a particle size having an integrated value of 50% in the second particle size distribution, and D₂50 has a unit of μm.

### CROSS-REFERENCE TO RELATED APPLICATION

This application claims priority to Japanese Patent Application No. 2023-219076 filed on Dec. 26, 2023, incorporated herein by reference in its entirety.

### BACKGROUND

### 1. Technical Field

The present disclosure relates to a bipolar electrode and a power storage device.

### 2. Description of Related Art

Japanese Unexamined Patent Application Publication No. 2023-91568 (JP 2023-91568 A) discloses the use of two types of cathode active materials having different average particle sizes, for the purpose of increasing volume capacity density of a cathode of a non-aqueous electrolyte secondary battery.

### SUMMARY

In JP 2023-91568 A, the volume capacity density of the cathode of the non-aqueous electrolyte secondary battery is improved, but there is room for improvement from the perspective of resistance.

Now, there is known a bipolar electrode (bipolar battery) having a cathode active material layer on one face of a current collector, and an anode active material layer on the other face thereof. Bipolar batteries have attracted attention from the perspective of improving energy density as compared with conventional non-aqueous electrolyte secondary batteries.

However, the cathode and the anode are pressed at the same time in bipolar electrodes, the cathode is not sufficiently pressed, and contact of the cathode active material is reduced. Also, in bipolar batteries, electric current flows in a thickness direction of the electrode, but when contact among the cathode active materials or between the cathode active materials and a conductive material is insufficient, a path over which the electric current flows becomes complicated, interrupted, or the like, and thus problems such as increase in resistance, deterioration in durability, and so forth, occur.

An object of the present disclosure is to provide a bipolar electrode and a power storage device in which increase in resistance is suppressed.

One aspect of the present disclosure provides a bipolar electrode. The bipolar electrode includes a cathode active material layer, an electrode current collector, and an anode active material layer, in this order.

The cathode active material layer includes a first cathode active material and a second cathode active material, with a layered crystal structure,
a particle size distribution of the first cathode active material is a first particle size distribution on a number basis,
a particle size distribution of the second cathode active material a second particle size distribution on a number basis,
the first cathode active material and the second cathode active material satisfy a relation of the following Expression (1)

$$1.5 < ( {D}_{1} 50 / {D}_{2} 50 ) \leq 15 , \qquad ( 1 )$$

in the above Expression (1), D₁50 represents a particle size with an integrated value of 50% in the first particle size distribution, and also an increment of D₁50 is m, and
in the above Expression (1), D₂50 represents a particle size with an integrated value of 50% in the second particle size distribution, and also an increment of D₂50 is μm.

The cathode active material of the present technology includes the first cathode active material and the second cathode active material. As shown in the above Expression (1), the first cathode active material has a greater D50 than the second cathode active material. It is anticipated that, due to the second cathode active material entering gaps among the first cathode active material, conductive paths will be formed, and as a result, increase in resistance will be suppressed.

Also “D₁50/D₂50” shown in the above Expression (1) is also referred to as “particle size ratio” or the like, for example. It is conceivable that when the particle size ratio is within a specific range, the second cathode active material will easily enter gaps among the first cathode active material.

In the bipolar electrode, the first cathode active material satisfies a relation of the following Expression (2), and
the second cathode active material satisfies a relation of the following Expression (3),

$$9 \leq {D}_{1} 50 \leq 20 \qquad ( 2 )$$

$$2 \leq {D}_{2} 50 \leq 5. \qquad ( 3 )$$

In the bipolar electrode, the first cathode active material satisfies a relation of the following Expression (4), and
the second cathode active material satisfies a relation of the following Expression (5),

$$( {D}_{1} 90 - {D}_{1} 10 ) / {D}_{1} 50 \leq 2.1 \qquad ( 4 )$$

$${D}_{2} 90 - {D}_{2} 10 ) / {D}_{2} 50 \leq 2.5 , \qquad ( 5 )$$

where
in the above Expression (4), D₁10 and D₁90 respectively represent a particle size having an integrated value of 10% and a particle size having an integrated value of 90% in the first particle size distribution, and also an increment of each of D₁10 and D₁90 is m, and in the above Expression (5), D₂10 and D₂90 respectively represent a particle size having an integrated value of 10% and a particle size having an integrated value of 90% in the second particle size distribution, and also an increment of each of D₂10 and D₂90 is μm.

The “(D90−D10)/D50” shown in Expressions (4) and (5) above is also referred to as “span-value” or the like, for example. The span value is an indicator of the extent of the particle size distribution. The smaller the span value is, the sharper the particle size distribution is considered to be. When the relations of the above Expressions (4) and (5) are satisfied, the amount of fine particles and coarse particles is reduced, and accordingly improvement in thermal stability is anticipated, in addition to suppression of increase in resistance.

Another aspect of the present disclosure provides a power storage device including a bipolar electrode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a bipolar electrode according to the present embodiment;

FIG. 2 is a schematic diagram showing an example of the cathode active material layer of the present embodiment;

FIG. 3 is a schematic diagram illustrating an example of the power storage device of the present embodiment;

FIG. 4 is a table showing the production conditions and analytical results of the cathode active materials used in Examples and Comparative Examples; and

FIG. 5 is a table showing sample configurations and evaluation results of Examples and Comparative Examples.

### DETAILED DESCRIPTION OF EMBODIMENTS

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

In this specification, when a compound is represented by a stoichiometric composition formula such as, for example, “LiCoO₂”, the stoichiometric composition formula is exemplary only. For example, when lithium cobalt oxide is expressed as “LiCoO₂”, unless otherwise specified, the lithium cobalt oxide is not limited to a composition ratio of “Li/Co/O=1/1/2”, and can include Li, Co and O in any composition ratio. The composition ratio may be non-stoichiometric.

In the present specification, at least one of the first cathode active material and the second cathode active material may be collectively referred to as a “cathode active material”. The “ratio of D50 of the second cathode active material to D50 of the first cathode active material” is also referred to as the “particle size ratio”.

In the context of “particle size distribution” herein, “D10”, “D50” and “D90” are defined as follows. D10 indicates a particle size (unit: km) in which the cumulative frequency (integrated value) from the smaller particle size is 10% in the particle size distribution on the number basis. D50 indicates the particle size in which the cumulative frequency from the smaller particle size becomes 50% in the particle size distribution on the number basis. D90 indicates the particle size in which the cumulative frequency from the smaller particle size becomes 90% in the particle size distribution on the number basis.

Herein, the volume-based particle size distribution is converted to a number-based particle size distribution. The volume-based particle size distribution can be measured by a laser diffraction particle size distribution measuring apparatus. The measurement procedure may be as follows. A measurement target (cathode active material) is prepared. A measurement sample (particle dispersion liquid) is prepared by mixing a measurement target, a dispersant, and a dispersion medium. The measurement sample is introduced into a laser diffraction type particle size distribution measuring apparatus, whereby a volume-based particle size distribution is measured.

### Bipolar Electrode

The bipolar electrode of the present embodiment is used as an electrode of a power storage device. The power storage device is, for example, a non-aqueous electrolyte secondary battery such as a lithium ion secondary battery. In the present embodiment, a bipolar electrode used in a lithium ion secondary battery will be described.

FIG. 1 is a schematic diagram illustrating an example of a bipolar electrode according to the present embodiment. The bipolar electrode 20 includes a cathode active material layer 21, an electrode current collector 10, and an anode active material layer 22 in this order. That is, the cathode active material layer 21 is bonded to one main surface of the electrode current collector 10, and the anode active material layer 22 is bonded to the other main surface.

### Cathode Active Material Layer

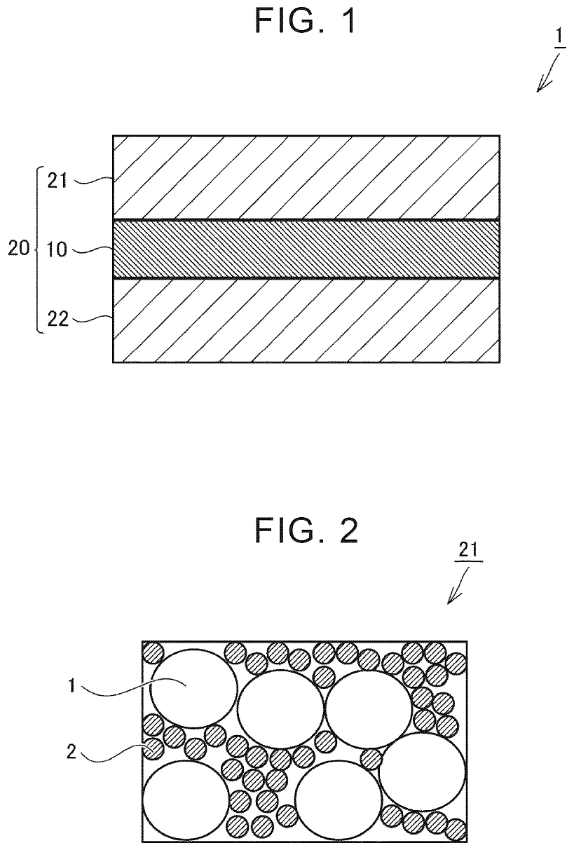

FIG. 2 is a schematic diagram illustrating an example of the cathode active material layer of the present embodiment. The cathode active material layer 21 includes a cathode active material. The cathode active material includes a first cathode active material 1 and a second cathode active material 2. The first cathode active material 1 and the second cathode active material 2 each have a layered crystal structure. The cathode active material can be identified by, for example, Inductively Coupled Plasma Atomic Emission Spectroscopy (ICP-AES).

### Cathode Active Material

The cathode active material of the present embodiment can absorb and release lithium ions reversibly. The cathode active material is a cathode active material containing a lithium metal-containing composite oxide. The cathode active material of the present embodiment may be a cathode active material made of a lithium metal-containing composite oxide. The lithium-metal-containing complex oxide may be, for example, at least one selected from the group consisting of LiCoO₂, LiNiO₂, LiMnO₂, Li(NiCoMn)O₂, and Li(NiCoAl)O₂. Among them, Li(NiCoMn)O₂ is preferable because the resistive property is particularly excellent. Such a lithium metal-containing composite oxide preferably has a composition represented by the following formula (i). The first cathode active material 1 and the second cathode active material 2 may have the same composition or different compositions. The chemical composition of the cathode active material can be measured by, for example, ICP-AES or the like.

Li_{z}Ni_{1-x-y}CoₓMn_{y}O₂ (i)

In the above formula (i), x, y, and z satisfy the relationships of 0.1≤x≤0.4, 0.1≤y≤0.5, and 0.95≤z≤1.2.

### First Cathode Active Material

The first cathode active material 1 is a large particle. The first cathode active material 1 has a particle size that is relatively larger than that of the second cathode active material 2. The first cathode active material 1 may contribute to improvement in energy density, input/output characteristics, storage characteristics, and the like. The first cathode active material 1 has a first particle size distribution on a number basis. The D₁50 is D50 in the first particle size distribution. The D₁50 may be, for example, 9 μm or more and 20 μm or less.

### Second Cathode Active Material

The second cathode active material 2 is a small particle. The second cathode active material 2 has a particle size that is relatively smaller than that of the first cathode active material 1. The second cathode active material 2 may form a conductive path between the large particles. The second cathode active material 2 may contribute to improvement in cycle durability. The second cathode active material 2 has a second particle size distribution on a number basis. The D₂50 is D50 in the second particle size distribution. The D₂50 may be, for example, 2 μm or more and 5 μm or less.

### Particle Size Ratio

The “particle size ratio (D₁50/D₂50)” in the present embodiment is obtained by dividing the D₁50 of the first cathode active material 1 by the D₂50 of the second cathode active material 2. The particle size ratio is greater than 1.5 and less than or equal to 15. When the particle size ratio is within the above range, suppression of an increase in resistance is expected. This is considered to be because the second cathode active material 2, which is small particles, easily enters the gaps between the first cathode active materials 1, which are large particles. The particle size ratio may be, for example, 1.8 or more, or 3.0 or more. The particle size ratio may be, for example, 10 or less, or 9.0 or less.

### Span Value

The first particle size distribution may be a sharper distribution than the second particle size distribution. That is, the first particle size distribution may have a smaller span value than the second particle size distribution. As a result, the amount of fine particles and coarse particles is reduced, and therefore, in addition to suppressing an increase in resistance, an improvement in thermal stability is expected.

The D₁10 is D10 in the first particle size distribution. The D₁90 is D90 in the first particle size distribution. The span of the first particle size distribution [(D₁90−D₁10)/D₁50] is less than or equal to 2.1.

The D₂10 is D10 in the second particle size distribution. The D₂90 is D90 in the second particle size distribution. The second particle size distribution span [(D₂90−D₂10)/D₂50] is less than or equal to 2.5.

### Content Ratio

The content ratio of the first cathode active material 1 and the second cathode active material 2 is not particularly limited. These mass-ratios (first cathode active material 1:second cathode active material 2) may be, for example, 30:70 to 70:30 or 40:60 to 60:40.

### Content

The content of the active material of the cathode active material layer 21, i.e., the total content of the first cathode active material 1 and the second cathode active material 2 to the total weight of the cathode active material layer 21, for example, may be 50% by mass, may be 70% by mass or more, it may be 80% by mass, may be 90% by mass or more, it may be 95% by mass or more, it is substantially 100% by mass.

### Other Ingredients

The cathode active material layer 21 may further include, for example, a conductive material, a binder, and the like. The conductive material may include, for example, acetylene black (AB). The binder may include, for example, PVDF or the like. The conductive material and the binder may be, for example, 0.1% by mass or more and 10% by mass or less with respect to the cathode active material layer 21.

### Preparation of Cathode Active Material

The cathode active material is prepared, for example, by the following procedure. Sulfates such as Ni are prepared. The sulfate is dissolved in water to form an acidic aqueous solution. For example, nickel sulfate, cobalt sulfate, and manganese sulfate may be dissolved in water to form an acidic aqueous solution.

A reaction vessel is prepared. An ammonium ion feeder such as aqueous ammonia is added to the reaction vessel, and the mixture is stirred. An aqueous alkaline solution is prepared by adding a pH adjusting agent such as sodium hydroxide to the reactor while stirring. The acidic aqueous solution is added dropwise to the alkaline aqueous solution while pH of the reaction solution is controlled to be constant. Thereby, a precipitate can be formed. The precipitate is believed to comprise a complex hydroxide (precursor). The precipitate is washed and filtered and dried to form a dry matter.

The mixture is formed by mixing the dry compound and the lithium compound. The lithium compound may include, for example, lithium carbonate, lithium hydroxide, and the like. The mixture is subjected to a heat treatment (calcination) to synthesize a lithium metal-containing composite oxide powder. A cathode active material is prepared by crushing the synthesized lithium metal-containing composite oxide powder.

In the present embodiment, a cathode active material having a desired D10, D50 and D90 can be prepared by appropriately adjusting the agitation rate in the reaction vessel, pH of the reaction solution, the mixing ratio of the ammonium ion supplier and the acidic solution, the dropping rate and the dropping time of the acidic solution, the firing temperature, the firing time, and the like.

### Electrode Current Collector

The electrode current collector 10 may include, for example, at least one selected from the group consisting of aluminum (Al), stainless steel, nickel (Ni), chrome (Cr), platinum (Pt), niobium (Nb), iron (Fe), titanium (Ti), copper (Cu), and zinc (Zn). The electrode current collector 10 may be formed by plating the surface of a metal foil.

### Anode Active Material Layer

The anode active material layer 22 includes an anode active material. The anode active material may include, for example, at least one selected from the group consisting of graphite, soft carbon, and hard carbon. The anode active material layer may further include, for example, a binder, a thickener, and the like. Examples of the binder include styrene butadiene rubber (SBR) and the like. Examples of the thickener include carboxymethylcellulose (CMC) and the like.

### Power Storage Device

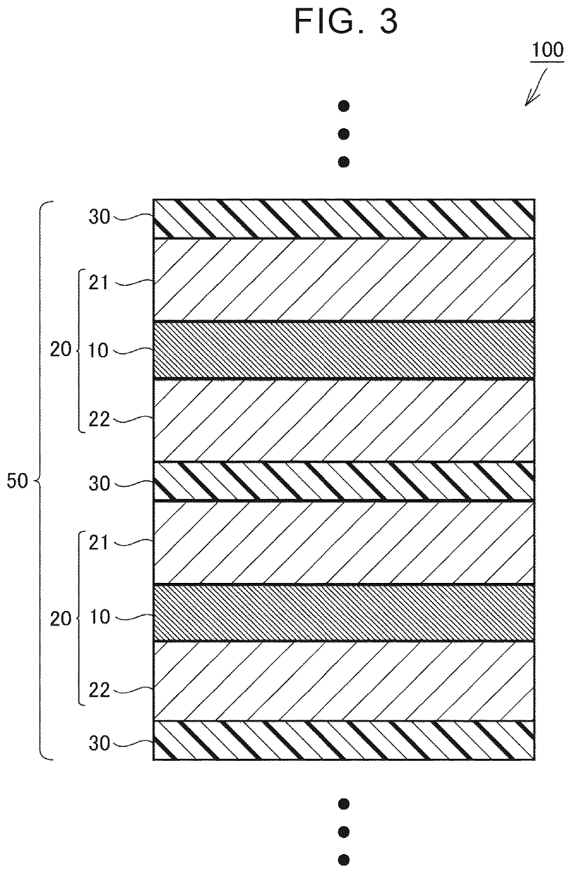

FIG. 3 is a schematic diagram illustrating an example of the power storage device of the present embodiment. In the present embodiment, a case where the power storage device 100 is a lithium ion secondary battery (hereinafter, may be abbreviated as a “battery”) will be described.

The battery 100 may include an exterior body (not shown). The exterior body may house the power generation element 50 and an electrolyte (not shown). The sheath may have any form. The exterior body may be, for example, a metal case or a pouch made of a metal foil laminate film. The outer casing may include, for example, an Al or the like.

The battery 100 includes a power generation element 50. The power generation element 50 may also be referred to as an electrode body or an electrode group. The power generation element 50 includes a bipolar electrode 20 and a separator 30. By alternately laminating the bipolar electrode 20 and the separator 30, the power generation element 50 can be formed.

### Separator

The separator 30 is porous. The separator 30 may pass through the electrolytic solution. The separator 30 separates the cathode active material layer 21 and the anode active material layer 22. The separator 30 is electrically insulating. The separator 30 may include, for example, a polyolefin-based resin such as polyethylene (PE) or polypropylene (PP). The separator 30 may have, for example, a single-layer structure or a multi-layer structure. The separator 30 may consist of, for example, substantially PE layers, and may be formed by laminating PP layers, PE layers, and PP layers in this order.

### Electrolytic Solution

The electrolyte solution includes solvents and Li salts. The solvent is aprotic. The solvent may comprise any component. The solvents may include, for example, at least one selected from the group consisting of ethylene carbonate (EC), dimethyl carbonate (DMC), and ethyl methyl carbonate (EMC).

Li salt is a supporting electrolyte. Li salt is dissolved in a solvent. Li salt may include, for example, at least one selected from the group consisting of LiPF₆ and LiBF₄. Li salt may have a molar concentration of, for example, 0.5 mol/L or more and 2.0 mol/L or less.

The electrolyte solution may further contain an optional additive. The electrolytic solution may contain, for example, 0.01% by mass or more and 5% by mass or less of an additive. The additive may include, for example, at least one selected from the group consisting of vinylene carbonate (VC), vinyl ethylene carbonate (VEC), and the like.

### Production of Cathode Active Material

### No. A

Acidic aqueous solutions were obtained by dissolving nickel sulfate, cobalt sulfate and manganese sulfate in ion-exchanged water. The molar ratio of Ni, Co and Mn in the aqueous acid solution was 8:1:1, and the concentration of the aqueous acid solution was 30% by mass.

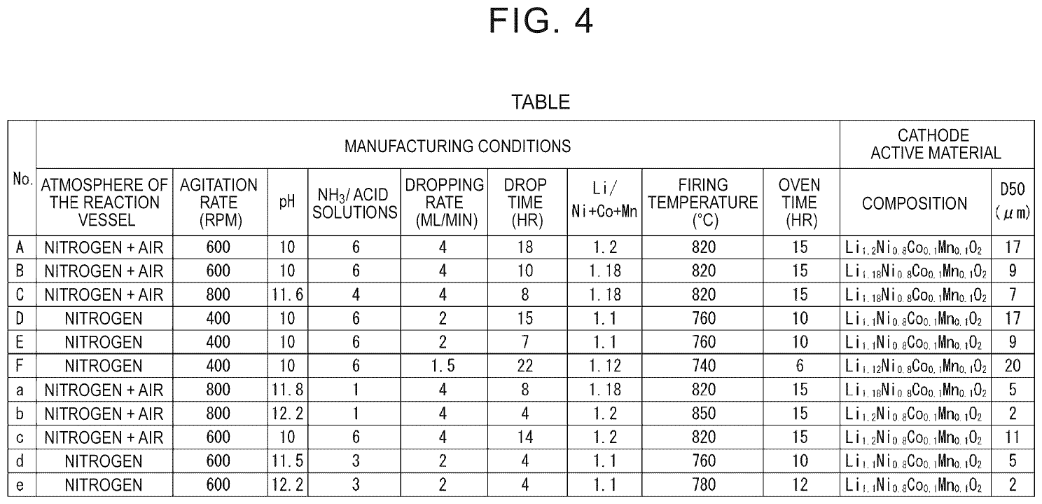

The reaction vessel was fed with ammonia water and stirred with a stirrer. Next, an aqueous alkaline solution was prepared by supplying an aqueous sodium hydroxide solution to the reaction vessel. While the aqueous alkali solution in the reaction vessel was stirred by the stirrer, the aqueous acid solution was added dropwise to the aqueous alkali solution. During the dropwise addition of the acidic aqueous solution, aqueous ammonia and aqueous sodium hydroxide were added as appropriate so that the ammonia level and pH of the reactant were constant. The precipitate after the reaction was washed with water and filtered to obtain a composite hydroxide. The resulting composite hydroxide was dried at 120° C. for 16 hours to obtain a dried product. In the above reaction, the atmosphere of the reaction vessel, the agitation rate, pH of the reaction solution, the mixing volume ratio of ammonia-water to the acidic solution (NH₃/acidic solution), the dropping rate of the acidic solution, and the dropping times are as shown in FIG. 4.

The dried product and lithium carbonate were mixed in a mortar to obtain a mixture. The mixture was calcined in a muffle furnace under an oxygen atmosphere to obtain a lithium metal-containing composite oxide powder. A No. A cathode active material was obtained by crushing the lithium-metal-containing complex oxide powder using a jet mill. The mixed molar ratio of Li to Ni, Co and Mn in the dry matter (Li/Ni+Co+Mn), calcination temperature and calcination time are as shown in FIG. 4.

Nos. B to F, Nos. a to e

A cathode active material of Nos. B to F and Nos. a to e was obtained by the same process as that of No. A except that the manufacturing conditions were changed as shown in FIG. 4. Note that each cathode active material of Nos. A to F is a first cathode active material, and each cathode active material of Nos. a to e is a second cathode active material.

### Composition

A ICP emission spectrometer (PS3520UVDD, manufactured by Hitachi High-Tech Science Co., Ltd.) was used to confirm the composition of the cathode active materials of the respective No. The results are shown in FIG. 4. In addition, the crystal structure of the respective No. was confirmed to have a layered crystal structure in any of the cathode active materials.

### Particle Size Distribution

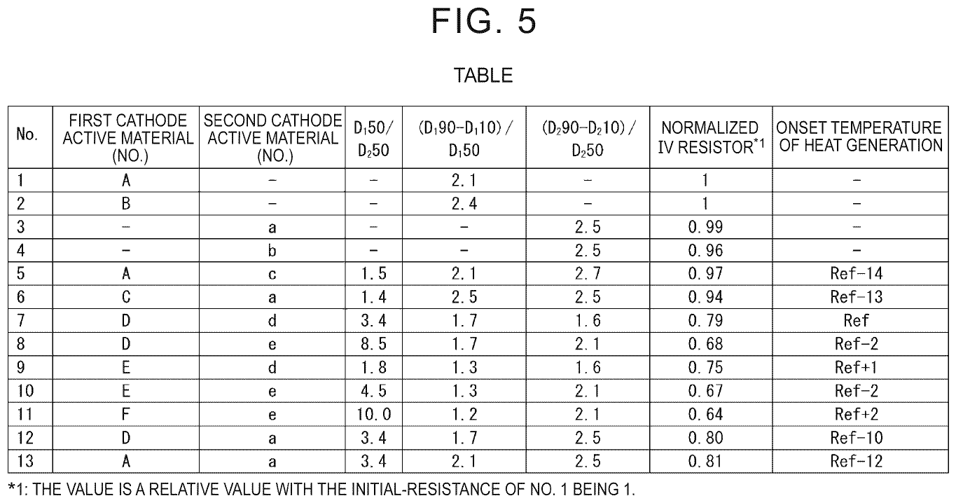

The volume-based particle size distribution of the cathode active material of the respective No. was measured by a laser-diffractive particle size distribution measuring device. The measured volume-based particle size distribution was converted to a number-based particle size distribution. D50 of the cathode active materials of the respective No. are shown in FIG. 4. Further, in the test cell for evaluation to be described later, the particle size ratio (D₁50/D₂50), the span value of the first particle size distribution [(D₁90−D₁10)/D₁50], and the span value of the second particle size distribution [(D₂90−D₂10)/D₂50] were obtained using D10, D50, and D90 of the obtained cathode active materials of the respective Nos. The effect is shown in FIG. 5.

### Manufacture of Lithium-Ion Secondary Batteries

As a material of the cathode active material layers, Nos. A to F and Nos. a to e cathode active materials, AB (Denka Co., Ltd.) as a conductive material, and PVdF (Kureha Co., Ltd.) as a binder were prepared. A cathode active material layer was prepared using the above-described material. The mass ratio of each material in the cathode active material layer is first cathode active material:second cathode active material:conductive material:binder=45:5:5:5.

As a material of the anode active material layer, natural graphite (Hitachi Chemical Co., Ltd.) as an anode active material, and SBR (JSR Co., Ltd.) as a binder, and CMC (Nippon Paper Industries Co., Ltd.) as a thickener were prepared. An anode active material layer was prepared using the above-described material. The mass ratio of each material in the anode active material layer is as follows: anode active material:binder:thickener=95:2.5:2.5.

An Al foil (thickness: 15 μm) was prepared as an electrode current collector. The cathode active material layer, the electrode current collector, and the anode active material layer were laminated in this order, thereby producing a bipolar electrode.

As separators, a porous resin (PP/PE/PP) (thickness: 24 μm) in which PP layers were laminated on both sides of a PE layer was prepared. A bipolar electrode, a separator, and a bipolar electrode were laminated so that the separator separated the cathode active material layer and the anode active material layer. Thus, an electrode body was formed.

As an exterior body, a pouch made of a laminate film was prepared. The electrode body was housed in the outer casing. As an electrolyte solution, a mixed solvent containing EC, a DMC, and EMC was prepared by dissolving a support salt (LiPF₆) at a 1 mol/L level. The electrolyte solution was injected into the exterior body. After the injection of the electrolyte solution, the outer casing was sealed. From the above, a test cell for evaluating Nos. 1 to 13 was manufactured. The first cathode active material and the second cathode active material used in the respective Nos. are shown in FIG. 5.

### Evaluation

### Normalized IV Resistor

SOC (State of Charge) of the test cell was adjusted to 50% by constant current-constant voltage (CC-CV) charge at 25° C. The current at constant current (CC) charge was 1 It. “1 It” is defined as the current at which the rated capacity of the cell is cut off in one hour. At a SOC of 50%, the cell was 3.7 V. After adjusting SOC, the cell was discharged at a 10 It current for 10 seconds with a 30 minute pause in between. Initial discharging resistance (normalized IV resistance) was obtained by the following equation (ii). The effect is shown in FIG. 5. The initial resistance in FIG. 5 is a relative value. No. 1 initial resistance is defined as 1.

$$r = ( {V}_{0} - {V}_{10} ) / current \qquad ( ii )$$

In the above formulae (ii), r represents a discharging resistor. The V₀ indicates a voltage at the beginning of discharging. The V₁₀ indicates a voltage when 10 seconds have elapsed from the beginning of discharging.

### Thermal Stability

The cell was charged to 4.2 V at 25° C. The bipolar electrode was recovered by disassembling the cell in the charged state. The drilling punch punched the sample from the bipolar electrode. Sample DSC (Differential Scanning Calorimetry) curves were obtained. The heating rate was 2° C./min and the end temperature was 350° C. In DSC curve, the exothermic onset temperature was read. It is considered that the higher the heat generation start temperature, the better the thermal stability. In the item of the heat generation start temperature in FIG. 5, “Ref” indicates the heat generation start temperature of No. 7. For example, “Ref+8” indicates 8° C. above Ref.

### Results

As shown in FIG. 5, the normalized IV resistivity is lower in Nos. 7 to 13 than in Nos. 1 to 6. In addition, in Nos. 5 to 13, the heat generation initiation temperature is high, that is, the thermal stability is good. From these results, Nos. 7 to 13 has a particle size ratio (D₁50/D₂50), a span value of the first particle size distribution [(D₁90−D₁10)/D₁50], and a span value of the second particle size distribution [(D₂90−D₂10)/D₂50] all within a predetermined range. Therefore, it is considered that Nos. 7 to 13 is compatible with suppressing increased resistivity and thermostability.

The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

What is claimed is:

1. A bipolar electrode comprising: a cathode active material layer; an electrode current collector; and an anode active material layer, in this order, wherein
the cathode active material layer includes a first cathode active material and a second cathode active material, with a layered crystal structure,
a particle size distribution of the first cathode active material is a first particle size distribution on a number basis,
a particle size distribution of the second cathode active material a second particle size distribution on a number basis,
the first cathode active material and the second cathode active material satisfy a relation of the following Expression (1)
$$1.5 < ( {D}_{1} 50 / {D}_{2} 50 ) \leq 15 , \qquad ( 1 )$$
where
in the above Expression (1), D₁50 represents a particle size with an integrated value of 50% in the first particle size distribution, and also an increment of D₁50 is μm, and
in the above Expression (1), D₂50 represents a particle size with an integrated value of 50% in the second particle size distribution, and also an increment of D₂50 is μm.

2. The bipolar electrode according to claim 1, wherein:
the first cathode active material satisfies a relation of the following Expression (2); and
the second cathode active material satisfies a relation of the following Expression (3),
$$9 \leq {D}_{1} 50 \leq 20 \qquad ( 2 )$$
$$2 \leq {D}_{2} 50 \leq 5. \qquad ( 3 )$$

3. The bipolar electrode according to claim 1, wherein:
the first cathode active material satisfies a relation of the following Expression (4); and
the second cathode active material satisfies a relation of the following Expression (5),
$$( {D}_{1} 90 - {D}_{1} 10 ) / {D}_{1} 50 \leq 2.1 \qquad ( 4 )$$
$$( {D}_{2} 90 - {D}_{2} 10 ) / {D}_{2} 50 \leq 2.5 , \qquad ( 5 )$$
where
in the above Expression (4), D₁10 and D₁90 respectively represent a particle size having an integrated value of 10% and a particle size having an integrated value of 90% in the first particle size distribution, and also an increment of each of D₁10 and D₁90 is μm, and
in the above Expression (5), D₂10 and D₂90 respectively represent a particle size having an integrated value of 10% and a particle size having an integrated value of 90% in the second particle size distribution, and also an increment of each of D₂10 and D₂90 is μm.

4. A power storage device comprising the bipolar electrode according to claim 1.
